(19) United States
(12) Patent Application Publication
(10) Pub. No.: US 2012/0268444 A1
(43) Pub. Date: Oct. 25, 2012

(54) LIQUID CRYSTAL DISPLAY DEVICE, POLARITY REVERSING METHOD, PROGRAM, AND RECORDING MEDIUM

(75) Inventor: Kohzoh Takahashi, Osaka-shi (JP)

(73) Assignee: SHARP KABUSHIKI KAISHA, Osaka-shi, Osaka (JP)

(21) Appl. No.: 13/511,070

(22) PCT Filed: Jul. 23, 2010
(86) PCT No.: PCT/JP2010/062462

§ 371 Date: May 21, 2012

(30) Foreign Application Priority Data
Nov. 24, 2009 (JP) 2009-266550

(51) Int. Cl. G09G 5/00

(52) U.S. Cl. 345/212

(57) ABSTRACT

A liquid crystal display device includes a polarity reversal control section for controlling a source voltage application section so as to make a transition from (i) a state in which voltages each having a first polarity are applied to respective electrodes of all pixels of a liquid crystal display panel to (ii) a state in which voltages each having a second polarity, which is opposite to the first polarity, are applied to the respective electrodes of all the pixels, the transition being made while more than one of the plurality of frame images are displayed in turn on the liquid crystal display panel. This allows prevention of occurrence of flicker and of an increase in power consumption.

### TECHNICAL FIELD

The present invention relates to a liquid crystal display device including an active matrix type liquid crystal display panel. Specifically, the present invention relates to a polarity reversing process of reversing a polarity of a voltage applied to an electrode of each pixel of the liquid crystal display panel in the liquid crystal display device.

### BACKGROUND ART

An active matrix type liquid crystal display panel is manufactured by sealing liquid crystals between two glass substrates. On one of the two glass substrates, (i) a plurality of pixel electrodes, which are arranged along a horizontal direction and a vertical direction, and (ii) a plurality of switching elements, which switches between on and off a voltage applied to each of the plurality of pixel electrodes, are provided. In many cases, a thin-film transistor (TFT) is used as a switching element.

On the other of the two glass substrates, a color filter and a counter electrode are provided. The two glass substrates are arranged so that a surface on which the pixel electrodes are provided and a surface on which the counter electrode is provided face each other. Generally, one of the two glass substrates on which the pixel electrodes and the switching elements are provided is called TFT substrate, and the other of the two substrates on which the counter electrode and the color filter are provided is called counter substrate.

In a liquid crystal panel of an active matrix type as described above, continuous application of a DC voltage causes image sticking. Because of this, an active matrix type liquid crystal panel is driven with an AC voltage. That is, voltages are applied to the pixel electrodes, which voltages are caused to change in polarity, every predetermined period, between positive (+) and negative (−) with respect to a voltage applied to the counter electrode. For example, polarities of voltages applied to the pixel electrodes are reversed every frame period. This technique is called frame inversion method.

However, according to frame inversion technique, screen flicker easily occurs due to a difference between a luminance obtained in a case where a positive voltage is applied and a luminance obtained in a case where a negative voltage is applied. In consideration of this, line inversion method, dot inversion method, and the like have been developed as techniques of a polarity reversing process for preventing occurrence of flicker. In line inversion method, polarities of voltages applied to respective pixels are reversed every scanning line or every set of adjacent scanning lines within a display frame period. In dot inversion method, polarities of voltages applied to respective pixels are reversed every pixel within a display frame period so that voltages having different polarities are applied to adjacent pixels, respectively.

Patent Literature 1 discloses a liquid crystal display device in which (i) a detection of whether or not flicker occurs is carried out and (ii) it is possible to switch between a one-line polarity reversal pattern and a two-line polarity reversal pattern, depending on whether or not flicker occurs.

### CITATION LIST

### Patent Literature

Patent Literature 1
Japanese Patent Application Publication, Tokukai, No. 2001-174783 A (Publication Date: Jun. 29, 2001)

### SUMMARY OF INVENTION

### Technical Problem

However, in a case where polarity inversion is carried out in accordance with line inversion method, voltages are applied to respective pixels so that polarities of the voltages are reversed every predetermined number of lines. As such, a lateral stripe may appear due to a difference in luminance caused by a difference in polarity of applied voltages. In addition, since it is necessary to reverse polarities every predetermined number of lines, inversion frequency is increased as compared with frame inversion method. This causes an increase in power consumption in a liquid crystal display device. An increase in power consumption is also experienced in the technique disclosed in Patent Literature 1 due to the difference in number of lines at which polarity inversion is carried out.

In a case where polarity inversion is carried out in accordance with dot inversion method, inversion frequency is increased to a larger extent than that in the line inversion method, since polarities of voltages applied to the respective pixels need to be reversed every pixel. Accordingly, power consumption in a liquid crystal display device is increased to a larger extent than that in the line inversion method.

As described above, the conventional polarity inversion method allows prevention of occurrence of flicker, but in order to attain the prevention effect, an increase in power consumption is inevitable.

The present invention is accomplished in view of the problem. A major object of the present invention is to provide a liquid crystal display device in which occurrence of flicker can be prevented and an increase in power consumption can be reduced.

### Solution to Problem

In order to attain the object, a liquid crystal display device in accordance with the present invention is a liquid crystal display device including: a liquid crystal display panel including a plurality of pixels arranged along a longitudinal direction and a lateral direction and displaying a plurality of frame images sequentially by switching between the plurality of frame images; a voltage application section applying voltages, each having a polarity, to respective electrodes of the plurality of pixels of the liquid crystal display panel; and polarity reversal controlling means for controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

The liquid crystal display device in accordance with the present invention includes the polarity reversal controlling means which controls the voltage application section so as to make a transition from (i) the state in which the voltages each having the first polarity are applied to the respective electrodes of all of the plurality of pixels of the liquid crystal display panel to (ii) the state in which the voltages each having the second polarity, which is opposite to the first polarity, are applied to the respective electrodes of all of the plurality of pixels. The switching between the plurality of frame images is carried out multiple times by the polarity reversal controlling means, during a time period from a time when reversal of the polarities of the voltages applied to the respective electrodes of all of the plurality of pixels of the liquid crystal display panel is started until the reversal is completed. That is, in the liquid crystal display device in accordance with the present invention, a plurality of frame images are displayed in the time period until the reversal of the polarities of the voltages applied to the respective electrodes of all of the plurality of pixels is completed.

As described above, in the liquid crystal display device in accordance with the present invention, a plurality of frame images are displayed in the time period until the completion of the polarity reversal of the voltages applied to the respective electrodes of all of the plurality of pixels. This makes it possible to reduce occurrence of flicker as compared with a case in which polarities of voltages applied to respective electrodes of all of a plurality of pixels are reversed from the first polarity to the second polarity in a single frame (that is, a conventional frame reversal method).

In addition, in the liquid crystal display device in accordance with the present invention, the polarity reversal of the voltages applied to the respective electrodes of all of the plurality of pixels does not have to be carried out in a single frame. As such, it is possible to have a time period during which no polarity reversal of applied voltages is carried out, other than the time period for reversing polarities of applied voltages. In a case of having the time period during which no polarity reversal of applied voltages is carried out, the time period during which the polarity reversal is carried out in the liquid crystal display device in accordance with the present invention is substantially shortened, as compared with the case in which the polarities of the voltages applied to the respective electrodes of all of the plurality of pixels are reversed every frame. This allows the liquid crystal display device in accordance with the present invention to have a low inversion frequency and, ultimately, achieve a reduction in power consumption.

As described above, in the liquid crystal display device in accordance with the present invention, occurrence of flicker can be prevented and an increase in power consumption can be reduced.

In order to attain the object, a polarity reversing method in accordance with the present invention is a polarity reversing method for use in a liquid crystal display device including: a liquid crystal display panel including a plurality of pixels arranged along a longitudinal direction and a lateral direction and displaying a plurality of frame images sequentially by switching between the plurality of frame images; and a voltage application section applying voltages, each having a polarity, to respective electrodes of the plurality of pixels of the liquid crystal display panel, said polarity reversing method comprising the step of: controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

The configuration brings about an effect similar to that brought about by the liquid crystal display device in accordance with the present invention.

### Advantageous Effects of Invention

The liquid crystal display device in accordance with the present invention includes the polarity reversal controlling means for controlling the voltage application section so as to make the transition from (i) the state in which voltages each having the first polarity are applied to the respective electrodes of all of the plurality of pixels of the liquid crystal display panel to (ii) the state in which the voltages each having the second polarity, which is opposite to the first polarity, are applied to the respective electrodes of all of the plurality of pixels.

This makes it possible to reduce occurrence of flicker in the liquid crystal display device in accordance with the present invention as compared with a case in which polarities of respective voltages applied to electrodes of all of a plurality of pixels are reversed from the first polarity to the second polarity in a single frame. In addition, the liquid crystal display device in accordance with the present invention can have an inversion frequency lower than that in a case in which polarities of voltages applied to respective electrodes of all of a plurality of pixels are reversed every frame. This allows a reduction in power consumption.

As described above, in the liquid crystal display device in accordance with the present invention, occurrence of flicker can be prevented and power consumption can be reduced.

### BRIEF DESCRIPTION OF DRAWINGS

FIG. 1 is a block diagram illustrating main parts of a liquid crystal display device in accordance with the present embodiment.

FIG. 2 is a view schematically showing a polarity reversing process corresponding to a case in which polarities of applied voltages are reversed on a line by line basis individually (or in groups) in a liquid crystal display device in accordance with the present embodiment.

FIG. 3 is a view schematically showing a polarity reversing process corresponding to a case in which polarities of applied voltages are reversed on a dot by dot basis individually (or in groups) in a liquid crystal display device in accordance with the present embodiment.

### DESCRIPTION OF EMBODIMENTS

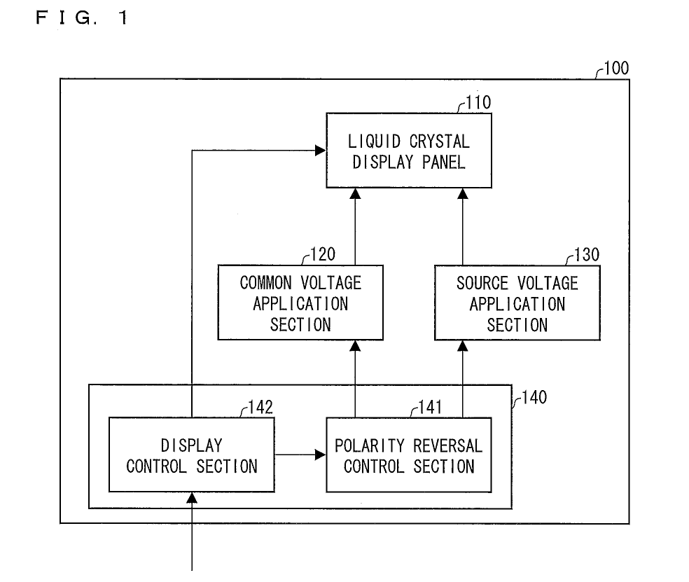

The following description will discuss, with reference to FIGS. 1 though 3, an embodiment of a liquid crystal display device in accordance with the present invention.

(Configuration of Liquid Crystal Display Device 100)

First, the following description will discuss, with reference to FIG. 1, a configuration of a liquid crystal display device in accordance with the present embodiment. FIG. 1 is a block diagram illustrating main parts of a liquid crystal display device 100 in accordance with the present embodiment.

As illustrated in FIG. 1, the liquid crystal display device 100 includes a liquid crystal display panel 110, a common voltage application section 120, a source voltage application section 130, and a control section 140. These members will be described below in more detail.

(Liquid Crystal Display Panel 110)

The liquid crystal display panel 110 is an active matrix type liquid crystal display panel. The liquid crystal display panel 110 is a TFT liquid crystal panel which employs a TFT as an active element and in which liquid crystals are sealed between two glass substrates (TFT substrate and counter substrate).

The TFT is a three-terminal switch constituted by (i) a thin-film semiconductor and (ii) a gate electrode, a source electrode, and drain electrode which are provided to the thin-film semiconductor. In a case where a voltage is applied to the gate electrode, an electric current flows from the source electrode to the drain electrode. In response to the electric current flowing from the source electrode to the drain electrode, a voltage is applied from the drain electrode to a pixel electrode. This causes a drive voltage to be applied to a liquid crystal element between the pixel electrode and a common electrode, which faces the pixel electrode. When the voltage applied to the gate electrode is changed to 0 V, (i) the TFT is turned off and (ii) a voltage which has been applied to the liquid crystal element and a voltage which has been applied to a storage capacitor are retained.

(Common Voltage Application Section 120 and Source Voltage Application Section 130)

The common voltage application section 120 applies a voltage to the common electrode provided on the counter substrate. The common electrode is a transparent electrode provided uniformly over an entire surface of the counter substrate. The source voltage application section 130 applies a voltage to a source electrode of a pixel of the TFT substrate.

The source voltage application section 130 can reverse a polarity of the voltage applied to the source electrode, in response to a polarity reversal signal supplied from the control section 140.

In a case where an electric current passed through the common electrode is an AC current, the common voltage application section 120 can also reverse a polarity of the voltage applied to the common electrode, in response to a polarity reversal signal supplied from the control section 140.

(Control Section 140)

The control section 140 controls processes in general which are conducted in the image display device 100. As illustrated in FIG. 1, the control section 140 includes a polarity reversal control section 141 and a display control section 142 (described below).

(Polarity Reversal Control Section 141)

The polarity reversal control section 141, when instructed by the display control section 142, instructs the source voltage application section 130 to reverse the polarity of the voltage applied by the source voltage application section 130 to the source electrode.

Specifically, the polarity reversal control section 141 supplies a polarity reversal signal to the source voltage application section 130. In the present embodiment, the source voltage application section 130 applies a positive voltage to the source electrode in a case where the polarity reversal signal is “H”, and applies a negative voltage to the source electrode in a case where the polarity reversal signal is “L”.

In the case where the electric current passed through to the common electrode is an AC current, the polarity reversal control section 141 similarly instructs the common voltage application section 120 to reverse the polarity of the voltage applied by the common voltage application section 120 to the common electrode.

(Display Control Section 142)

The display control section 142 supplies a frame image, which constitutes a video content externally obtained, to the liquid crystal display panel 110 at predetermined timing and for a predetermined time period. The liquid crystal display panel 110 displays the frame image while the frame image is being supplied. For example, in a case where the video content has 60 fps (frames per second), (i) the display control section 142 supplies each frame image to the liquid crystal display panel 110 for a 1/60 second and (ii) the liquid crystal display panel 110 displays each frame image for a 1/60 second.

In a case where a time period during which frame images are supplied exceeds a predetermined threshold, the display control section 142 instructs the polarity reversal control section 141 to reverse (i) the polarity of the voltage applied to the common electrode of the liquid crystal display panel or (ii) the polarity of the voltage applied to the source electrode of the liquid crystal display panel.

In other words, in a case where the number of frames which have been displayed in series without polarity reversal (i.e., frames which have been displayed by applying either a positive voltage or a negative voltage to each of the pixel electrodes of all the pixels included in the liquid crystal display panel 110) exceeds a predetermined number, the display control section 142 instructs the polarity reversal control section 141 to reverse (i) the polarity of the voltage applied to the common electrode of the liquid crystal display panel or (ii) the polarity of the voltage applied to the source electrode of the liquid crystal display panel. Note that the predetermined number can be set to a value that can optimize an effect of reduction in power consumption and in flicker.

(Polarity Reversed on a Line by Line Basis Individually or in Groups)

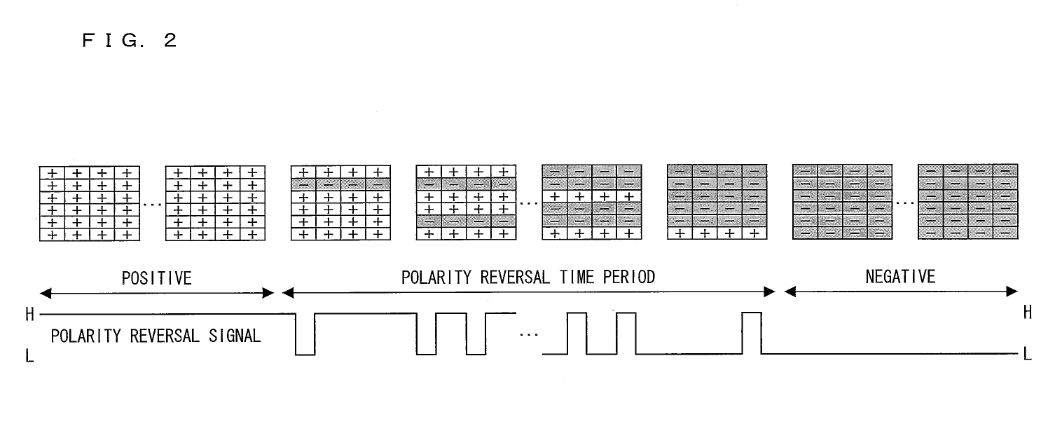

Next, with reference to FIG. 2, the following description will discuss in detail, as an example of polarity reversal carried out in the liquid crystal display device 100, how a polarity reversing process is carried out in a case where polarities are reversed on a line by line (scanning line by scanning line) basis individually or in groups. FIG. 2 is a view schematically showing a case in which the polarities are reversed on a line by line basis individually or in groups in the liquid crystal display device 100. Note that, although FIG. 2 shows an example in which polarities of voltages applied to respective source electrodes are reversed from positive to negative, the following description applies also to a case in which polarities of the voltages applied to the respective source electrodes are reversed from negative to positive.

In a case where a time period during which frame images are supplied to the liquid crystal display panel exceeds a predetermined threshold, the display control section 142 instructs the polarity reversal control section 141 to reverse (i) the polarities of the voltages applied to the respective source electrodes and (ii) a polarity of a voltage applied to the common electrode.

Upon reception of the instruction, the polarity reversal control section 141 supplies a polarity reversal signal to the common voltage application section 120 and to the source voltage application section 130.

At this time, as shown in FIG. 2, reversal of (i) the polarities of the voltages applied to the respective source electrodes and (ii) the polarity of the voltage applied to the common electrode is carried out over a time period during which a plurality of frame images are displayed. For example, in a case where (i) the liquid crystal display panel 110 is a panel having 100 lines and (ii) polarities of voltages applied are reversed on a line by line basis, reversal of the polarities of the voltages is accomplished using 100 frames.

In more general terms, in a case where (i) the liquid crystal display panel 110 is a panel having N1 lines and (ii) polarities of voltages applied to respective pixel electrodes of pixels arranged on the N1 lines are reversed on a line by line basis in groups of M1 lines, reversal of the polarities of the voltages applied to the pixel electrodes of all the pixels included in the liquid crystal display panel 110 is accomplished using N1/M1 frames.

The following description will discuss in more detail, with reference to FIG. 2, the example of the polarity reversing process of applied voltages. In a frame that comes immediately after the polarity reversing process has been started, polarities of voltages applied to respective source electrodes of pixels in a second line are reversed. In so doing, at the time of applying the voltages to the respective source electrodes of the pixels in the second line, the polarity reversal control section 141 supplies a polarity reversal signal of “L” to the source voltage application section 130. This causes the source voltage application section 130 to apply negative voltages to the respective source electrodes of the pixels in the second line.

At the time of applying voltages to source electrodes of pixels in the lines following the second line, the polarity reversal control section 141 supplies a polarity reversal signal of “H” to the source voltage application section 130. This causes the source voltage application section 130 to apply positive voltages to the respective source electrodes of the pixels in the lines following the second line.

When the next frame image is displayed, the polarity reversal control section 141 supplies a polarity reversal signal of “L” to the source voltage application section 130 at the time of applying voltages to respective source electrodes of pixels in a fifth line, as well as at the time of applying voltages to the respective source electrodes of the pixels in the second line. This causes the source voltage application section 130 to apply negative voltages to the respective source electrodes of the pixels in the fifth line, in addition to the respective source electrodes of the pixels in the second line.

By repeating similar processes, the source voltage application section 130 will eventually apply negative voltages to the respective source electrodes of the pixels on all the lines. At this stage, the polarity reversal control section 141 keeps supplying a polarity reversal signal of “L” to the source voltage application section 130.

Note that, in order that an amplitude of a voltage applied to a source electrode can be reduced by half, it is preferable that the common voltage application section 120 reverse, in synchronization with reversal of a voltage applied to a source electrode, a polarity of a voltage applied to the common electrode. That is, the common voltage application section 120 reverses the polarity of the voltage applied to the common electrode, in accordance with a fall and a rise of a polarity reversal signal supplied from the polarity reversal control section 141.

In the case where the polarities of applied voltages are reversed on a line by line basis individually or in groups, line(s) at which polarities of applied voltages are reversed while a frame image is being displayed are preferably not adjacent to line(s) at which polarities of applied voltages were reversed while an immediately preceding frame image was being displayed. This makes it possible to prevent a problem that a continuation of lines, at which polarities of applied voltages are reversed, causes a striped pattern in an image displayed on the liquid crystal display panel 110.

(Polarity Reversed on a Dot by Dot Basis Individually or in Groups)

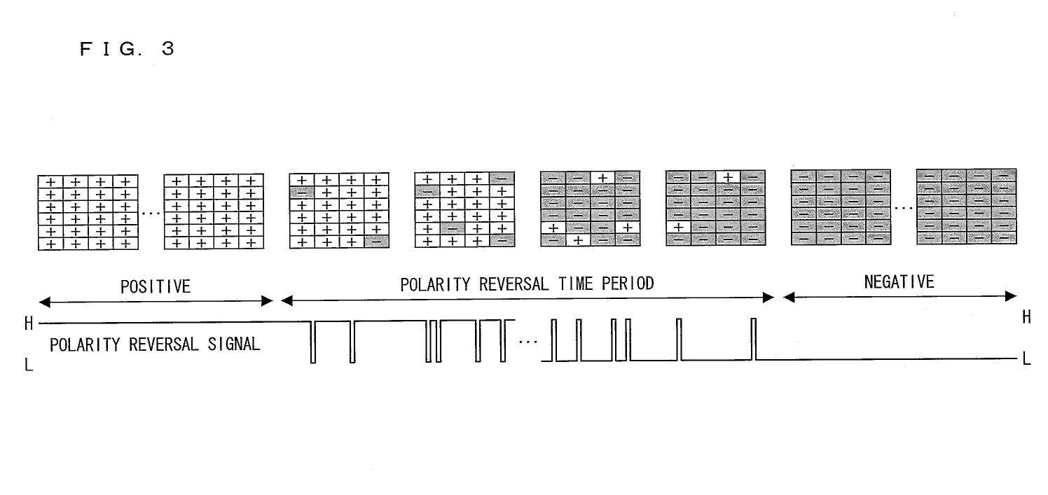

Next, with reference to FIG. 3, the following description will discuss in detail, as an example of polarity reversal carried out in the liquid crystal display device 100, how a polarity reversing process is carried out in a case where polarity is reversed on a dot by dot (pixel by pixel) basis individually or in groups. FIG. 3 is a view schematically showing a case in which the polarity is reversed on a dot by dot basis individually or in groups in the liquid crystal display device 100. Like FIG. 2, FIG. 3 shows an example in which polarities of voltages applied to respective source electrodes are reversed from positive to negative. Note that the following description applies also to a case in which polarities of the voltages applied to the respective source electrodes are reversed from negative to positive.

In a case where a time period during which frame images are supplied to the liquid crystal display panel exceeds a predetermined threshold, the display control section 142 instructs the polarity reversal control section 141 to reverse the polarities of the voltages applied to the respective source electrodes. Upon reception of the instruction, the polarity reversal control section 141 supplies a polarity reversal signal to the source voltage application section 130. Note that a polarity of a voltage applied to the common electrode is not reversed in the case of reversing polarities of voltages on a dot by dot basis individually or in groups, since the voltage applied to the common electrode is a DC voltage.

As shown in FIG. 3, also in the case of reversing polarities on a dot by dot basis individually or in groups, reversal of the polarities of the voltages applied to the respective source electrodes is carried out over a time period during which a plurality of frame images are displayed. For example, in a case where (i) the liquid crystal display panel 110 is a panel having 100 pixels (dots) and (ii) polarities of voltages applied are reversed at two dots per frame, reversal of the polarities is accomplished using 50 frames.

In more general terms, in a case where (i) the liquid crystal display panel 110 is a panel having Nd pixels and (ii) polarities of voltages applied to respective pixel electrodes of the Nd pixels are reversed on a dot by dot basis in groups of Md pixels, reversal of the polarities of the voltages applied to the pixel electrodes of all the pixels included in the liquid crystal display panel 110 is accomplished using Nd/Md frames.

The following description will discuss in more detail, with reference to FIG. 3, the example of the polarity reversing process of applied voltages. In a frame that comes immediately after the polarity reversing process of the voltages applied has been started, (i) a polarity of a voltage applied to a source electrode of a leftmost pixel in the second line and (ii) a polarity of a voltage applied to a source electrode of a rightmost pixel in a sixth line are reversed. In so doing, at the time of applying the voltage to the source electrode of the leftmost pixel in the second line and at the time of applying the voltage to the source electrode of the rightmost pixel in the sixth line, the polarity reversal control section 141 supplies a polarity reversal signal of “L” to the source voltage application section 130. This causes the source voltage application section 130 to apply a negative voltage to each of (i) the source electrode of the leftmost pixel in the second line and (ii) the source electrode of the rightmost pixel in the sixth line.

At the time of applying a voltage to each of the source electrodes other than (i) the source electrode of the leftmost pixel in the second line and (ii) the source electrode of the rightmost pixel in the sixth line, the polarity reversal control section 141 supplies a polarity reversal signal of “H” to the source voltage application section 130. This causes the source voltage application section 130 to apply positive voltages to the respective source electrodes other than (i) the source electrode of the leftmost pixel in the second line and (ii) the source electrode of the rightmost pixel in the sixth line.

When the next frame image is displayed, the polarity reversal control section 141 supplies a polarity reversal signal of “L” to the source voltage application section 130 at the time of applying a voltage to a source electrode of a rightmost pixel in a first line and at the time of applying a voltage to a source electrode of a second pixel to the left in a fifth line, as well as at the time of applying voltages to the pixels (the leftmost pixel in the second line and the rightmost pixel in the sixth line) each of which includes the source electrode to which the voltage whose polarity was reversed was previously applied. This causes the source voltage application section 130 to apply a negative voltage to each of (i) the source electrode of the rightmost pixel in the first line and (ii) the source electrode of the second pixel to the left in the fifth line, in addition to the respective source electrodes, to each of which the voltage whose polarity was reversed was previously applied.

By repeating similar processes, the source voltage application section 130 will eventually apply negative voltages to the respective source electrodes of all the pixels. At this stage, the polarity reversal control section 141 keeps supplying a polarity reversal signal of “L” to the source voltage application section 130.

In the case where polarities of voltages applied are reversed on a dot by dot basis individually or in groups, a pixel(s) each including a source electrode, to which a voltage whose polarity is reversed is applied while a frame image is being displayed, is preferably not adjacent to a pixel(s) each including a source electrode, to which a voltage whose polarity was reversed was applied while an immediately preceding frame image was being displayed. This makes it possible to prevent a problem that a continuation of pixels each including a source electrode, to which a voltage whose polarity is reversed is applied, causes flicker in an image displayed on the liquid crystal display panel 110.

Note that the polarity reversal can be carried out on a pixel by pixel (dot by dot) basis individually or in groups of a plurality of pixels that are adjacent to each other.

Alternatively, the polarity reversal can be carried out on a pixel by pixel (dot by dot) basis in groups of a plurality of pixels that are not adjacent to each other, as described above.

(Advantages of Liquid Crystal Display Device 100)

As described above, the polarity reversal control section 141 in the liquid crystal display device 100 switches between frame images multiple times during a time period from a time when the reversal of the polarities of the voltages applied to the respective electrodes of all of the pixels of the liquid crystal display panel 110 is started until the reversal is completed. As such, in the liquid crystal display device 100, a plurality of frame images are displayed in the time period until the completion of the polarity reversal of the voltages applied to the respective electrodes of all of the pixels. In other words, the polarity reversal is carried out in such a manner that (i) there is an imbalance in polarity in each of the plurality of frames that are displayed while the polarity reversal is carried out and (ii) a balance in polarity is recognized when the time period during which the polarity reversal is carried out is considered as a whole.

As described above, in the liquid crystal display device 100, occurrence of flicker can be reduced as compared with a case in which the polarity reversal of the voltages applied to the respective electrodes of all the pixels are carried out in a single frame.

In addition, in the liquid crystal display device 100, the polarity reversal of the voltages applied to the respective electrodes of all the pixels does not have to be carried out in a single frame. This allows having a time period during which no polarity reversal of applied voltages is carried out, other than the time period for reversing polarities of applied voltages (polarity reversal time period). In a case of having the time period during which no polarity reversal of applied voltages is carried out (that is, in a case of having a time period during which either positive voltages or negative voltages are applied in all of a predetermined number of frames), the time period during which the polarity reversal is carried out in the liquid crystal display device 100 is substantially shortened, as compared with the case in which the polarities of the voltages applied to the respective electrodes of all the pixels are reversed every frame. This allows the liquid crystal display device 100 to have a low inversion frequency and, ultimately, achieve a reduction in power consumption.

As described above, in the liquid crystal display device 100, occurrence of flicker can be prevented and an increase in power consumption can be reduced.

(Additional Matter)

The present embodiment has described the case in which the number of pixels at which the reversal of an applied voltage is carried out increases every time the switching between the frame images is carried out. Note that the present embodiment is not limited to this. The polarity reversal of an applied voltage does not have to be carried out every single time the switching between the frame images is carried out. For example, the number of pixels at which the polarity reversal of an applied voltage is carried out can be increased every n frames (n≧2).

(Program and Recording Medium)

Note that the control section 140 included in the liquid crystal display device 100 can be (i) configured as a hardware logic or (ii) realized by means of software by use of a CPU (Central Processing Unit) as described below.

That is, the control section 140 includes a CPU, such as an MPU, for executing commands of a program for implementing each function, a ROM (Read Only Memory) in which the program is stored, a RAM (Random Access Memory) on which the program is loaded in an executable format, a storage device (recording medium), such as a memory, in which the program and various data are stored, and the like.

An object of the present invention can be attained not only in a case where the program is fixedly carried in program memory in the control section 140 but also by the following procedures (i) and (ii): (i) loading, to the liquid crystal display device 100, the recording medium, in which program code (an executable program, an intermediate code program, or a source program) of the program is recorded and (ii) causing the liquid crystal display device 100 to read out and execute the program code recorded in the recording medium.

The recording medium is not limited to a recording medium with a specific structure or of a specific type. That is, for example, a tape such as a magnetic tape or a cassette tape, a disk including (i) a magnetic disk such as a Floppy® disk or a hard disk and (ii) an optical disc such as a CD-ROM, an MO, an MD, a DVD, or a CD-R, a card such as an IC card (including a memory card) or an optical card, a semiconductor memory such as a mask ROM, an EPROM, an EEPROM, or a flash ROM, or the like can be used as the recording medium.

Further note that an object of the present invention can be attained by configuring the control section 140 (or the liquid crystal display device 100) so as to be capable of being connected to a communications network. In this case, the program code is loaded to the control section 140 via the communications network. The communications network is not limited to any particular type or in any particular manner as long as the program code can be delivered to the control section 140. The communications network can be, for example, an internet, an intranet, an extranet, a LAN, an ISDN, a VAN, a CATV communications network, a virtual private network, a telephone network, a mobile telecommunications network, a satellite communication network or the like.

A transmission medium that constitutes the communications network can be any medium capable of transmitting program code and is not limited to a transmission medium with a specific configuration or a specific type. The examples of the transmission medium encompass (i) wired communications such as IEEE1394, USB, a power-line carrier, a CATV line, a telephone line, or ADSL (Asymmetric Digital Subscriber Line) and (ii) wireless communications such as infrared communication by means of IrDA or remote control, Bluetooth®, 802.11 wireless, HDR, a mobile phone network, a satellite circuit, or a terrestrial digital network. Note that the present invention can be realized also by means of a computer data signal embedded in a carrier wave, which computer data signal is obtained by embodying the program code in electronic transmission.

(Conclusion)

As described above, a liquid crystal display device in accordance with the present invention includes: a liquid crystal display panel including a plurality of pixels arranged along a longitudinal direction and a lateral direction and displaying a plurality of frame images sequentially by switching between the plurality of frame images; a voltage application section applying voltages, each having a polarity, to respective electrodes of the plurality of pixels of the liquid crystal display panel; and polarity reversal controlling means for controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

The liquid crystal display device in accordance with the present invention includes the polarity reversal controlling means which controls the voltage application section so as to make a transition from (i) the state in which the voltages each having the first polarity are applied to the respective electrodes of all of the plurality of pixels of the liquid crystal display panel to (ii) the state in which the voltages each having the second polarity, which is opposite to the first polarity, are applied to the respective electrodes of all of the plurality of pixels. The switching between the plurality of frame images is carried out multiple times by the polarity reversal controlling means, during a time period from a time when reversal of the polarities of the voltages applied to the respective electrodes of all of the plurality of pixels of the liquid crystal display panel is started until the reversal is completed. That is, in the liquid crystal display device in accordance with the present invention, a plurality of frame images are displayed in the time period until the reversal of the polarities of the voltages applied to the respective electrodes of all of the plurality of pixels is completed.

As described above, in the liquid crystal display device in accordance with the present invention, a plurality of frame images are displayed in the time period until the completion of the polarity reversal of the voltages applied to the respective electrodes of all of the plurality of pixels. This makes it possible to reduce occurrence of flicker as compared with a case in which polarities of voltages applied to respective electrodes of all of a plurality of pixels are reversed from the first polarity to the second polarity in a single frame (that is, a conventional frame reversal method).

In addition, in the liquid crystal display device in accordance with the present invention, the polarity reversal of the voltages applied to the respective electrodes of all of the plurality of pixels does not have to be carried out in a single frame. As such, it is possible to have a time period during which no polarity reversal of applied voltages is carried out, other than the time period for reversing polarities of applied voltages. In a case of having the time period during which no polarity reversal of applied voltages is carried out, the time period during which the polarity reversal is carried out in the liquid crystal display device in accordance with the present invention is substantially shortened, as compared with the case in which the polarities of the voltages applied to the respective electrodes of all of the plurality of pixels are reversed every frame. This allows the liquid crystal display device in accordance with the present invention to have a low inversion frequency and, ultimately, achieve a reduction in power consumption.

As described above, in the liquid crystal display device in accordance with the present invention, occurrence of flicker can be prevented and an increase in power consumption can be reduced.

In the liquid crystal display device in accordance with the present invention, it is preferable that the polarity reversal controlling means control the voltage application section so that a polarity of a voltage applied to an electrode of each of pixels arranged along at least one of a plurality of scanning lines in the liquid crystal display panel is reversed from the first polarity to the second polarity, every time the switching between the plurality of frame images is carried out.

According to the configuration, the polarity reversal controlling means causes a polarity of a voltage applied to an electrode of each of pixels arranged along the same scanning line(s) in the liquid crystal display panel to be reversed from the first polarity to the second polarity, every time the switching between the plurality of frame images is carried out. This allows an efficient prevention of occurrence of flicker in the liquid crystal display device in accordance with the present invention.

In the liquid crystal display device in accordance with the present invention, it is preferable that, among the plurality of scanning lines, a scanning line and another scanning line be not adjacent to each other, the scanning line being provided with the pixels each of which includes the electrode, to which the voltage whose polarity is reversed from the first polarity to the second polarity is applied when a current frame image is displayed, the another scanning line being provided with pixels each of which includes an electrode, to which a voltage whose polarity was reversed from the first polarity to the second polarity was applied when an immediately preceding frame image was displayed.

According to the configuration, the polarity reversal controlling means controls polarity reversal so that, among the plurality of scanning lines, (i) the scanning line provided with the pixels each including the electrode, to which the voltage whose polarity is reversed from the first polarity to the second polarity is applied when the current frame image is displayed, and (ii) the another scanning line, at which polarity reversal was carried out when the immediately preceding frame image was displayed, are not adjacent to each other.

This allows the liquid crystal display device in accordance with the present invention to prevent a striped pattern from appearing on the liquid crystal display panel, which striped pattern is caused by a continuation of scanning lines provided with pixels each including an electrode, to which a voltage whose polarity is reversed to the second polarity is applied.

In the liquid crystal display device in accordance with the present invention, it is preferable that the polarity reversal controlling means control the voltage application section so that a polarity of a voltage applied to an electrode of at least one of the plurality of pixels of the liquid crystal display panel is reversed from the first polarity to the second polarity, every time the switching between the plurality of frame images is carried out.

According to the configuration, the polarity reversal controlling means controls polarity reversal so that the polarity of the voltage applied to the electrode of the at least one of the plurality of pixels of the liquid crystal display panel is reversed from the first polarity to the second polarity, every time the switching between the plurality of frame images is carried out. This allows better prevention of occurrence of flicker in the liquid crystal display device in accordance with the present invention.

In the liquid crystal display device in accordance with the present invention, it is preferable that, among the plurality of pixels, a pixel and another pixel be not adjacent to each other, the pixel including the electrode, to which the voltage whose polarity is reversed from the first polarity to the second polarity is applied when a current frame image is displayed, the another pixel including an electrode, to which a voltage whose polarity was reversed from the first polarity to the second polarity was applied when an immediately preceding frame image was displayed.

According to the configuration, the polarity reversal controlling means controls polarity reversal so that (i) the pixel including the electrode, to which the voltage whose polarity is reversed from the first polarity to the second polarity is applied when the current frame image is displayed, and (ii) the another pixel, at which the polarity reversal is carried out when the immediately preceding frame image was displayed, are not adjacent to each other.

This allows the liquid crystal display device in accordance with the present invention to prevent flicker from appearing on the liquid crystal display panel, which flicker is caused by a continuation of pixels each including an electrode, to which a voltage whose polarity is reversed to the second polarity is applied.

In order to attain the object, a polarity reversing method in accordance with the present invention is a polarity reversing method for use in a liquid crystal display device including: a liquid crystal display panel including a plurality of pixels arranged along a longitudinal direction and a lateral direction and displaying a plurality of frame images sequentially by switching between the plurality of frame images; and a voltage application section applying voltages, each having a polarity, to respective electrodes of the plurality of pixels of the liquid crystal display panel, said polarity reversing method comprising the step of: controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

The configuration brings about an effect similar to that brought about by the liquid crystal display device in accordance with the present invention.

Note that (i) a program for causing the liquid crystal display device in accordance with the present invention to operate, which program is characterized by causing a computer to function as polarity reversal controlling means and (ii) a computer-readable recording medium in which the program is recorded, are also included in the scope of the present invention.

The present invention is not limited to the above-described embodiments but allows various modifications within the scope of the claims. Any embodiment obtained by appropriately combining the technical means disclosed in the embodiments will also be included in the technical scope of the present invention.

### INDUSTRIAL APPLICABILITY

The liquid crystal display device in accordance with the present invention can be suitably applied to a liquid crystal TV including an active matrix type liquid crystal display panel.

### REFERENCE SIGNS LIST

100: liquid crystal display device
110: liquid crystal display panel
120: common voltage application section
130: source voltage application section (voltage application section)
140: control section
141: polarity reversal control section (polarity reversal controlling means)
142: display control section

1. A liquid crystal display device comprising:
a liquid crystal display panel including a plurality of pixels arranged along a longitudinal direction and a lateral direction and displaying a plurality of frame images sequentially by switching between the plurality of frame images;
a voltage application section applying voltages, each having a polarity, to respective electrodes of the plurality of pixels of the liquid crystal display panel; and
polarity reversal controlling means for controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

2. The liquid crystal display device as set forth in claim 1,
wherein:
the polarity reversal controlling means controls the voltage application section so that a polarity of a voltage applied to an electrode of each of pixels arranged along at least one of a plurality of scanning lines in the liquid crystal display panel is reversed from the first polarity to the second polarity, every time the switching between the plurality of frame images is carried out.

3. The liquid crystal display device as set forth in claim 2,
wherein:
among the plurality of scanning lines, a scanning line and another scanning line are not adjacent to each other,
the scanning line being provided with the pixels each of which includes the electrode, to which the voltage whose polarity is reversed from the first polarity to the second polarity is applied when a current frame image is displayed,
the another scanning line being provided with pixels each of which includes an electrode, to which a voltage whose polarity was reversed from the first polarity to the second polarity was applied when an immediately preceding frame image was displayed.

4. The liquid crystal display device as set forth in claim 1, wherein the polarity reversal controlling means controls the voltage application section so that a polarity of a voltage applied to an electrode of at least one of the plurality of pixels of the liquid crystal display panel is reversed from the first polarity to the second polarity, every time the switching between the plurality of frame images is carried out.

5. The liquid crystal display device as set forth in claim 4,
wherein:
among the plurality of pixels, a pixel and another pixel are not adjacent to each other,
the pixel including the electrode, to which the voltage whose polarity is reversed from the first polarity to the second polarity is applied when a current frame image is displayed,
the another pixel including an electrode, to which a voltage whose polarity was reversed from the first polarity to the second polarity was applied when an immediately preceding frame image was displayed.

6. A polarity reversing method for use in a liquid crystal display device including:
a liquid crystal display panel including a plurality of pixels arranged along a longitudinal direction and a lateral direction and displaying a plurality of frame images sequentially by switching between the plurality of frame images; and
a voltage application section applying voltages, each having a polarity, to respective electrodes of the plurality of pixels of the liquid crystal display panel,
said polarity reversing method comprising the step of:
controlling the voltage application section so as to make a transition from (i) a state in which voltages each having a first polarity are applied to the respective electrodes of all of the plurality of pixels of the liquid crystal display panel to (ii) a state in which voltages each having a second polarity, which is opposite to the first polarity, are applied to the respective electrodes of all of the plurality of pixels, the transition being made while more than one of the plurality of frame images are displayed in turn on the liquid crystal display panel.

7. A program for (i) causing a computer included in a liquid crystal display device recited in claim 1 to operate and (ii) causing the computer to function as the polarity reversal controlling means.

8. A computer-readable recording medium in which a program recited in claim 7 is recorded.
